(19) United States
(12) Patent Application Publication
(10) Pub. No.: US 2006/0006630 A1
(43) Pub. Date: Jan. 12, 2006

(54) Gas bag module

(75) Inventor: Volker Schwarz, Alfdorf-Burgholz (DE)

Correspondence Address: TAROLLI, SUNDHEIM, COVELL, & TUMMINO L.L.P.;1111 LEADER BLDG., 526 SUPERIOR AVENUE, CLEVELAND, OH, 44114-1400, US

(73) Assignee: TRW Automotive GmbH

(21) Appl. No.: 11/166,602

(22) Filed: Jun. 24, 2005

(30) Foreign Application Priority Data
Jul. 9, 2004 (DE) 20 2004 010 785.6

(51) Int. Cl. B60R 21/16

(52) U.S. Cl. 280/728.2

(57) ABSTRACT

A gas bag module has a gas bag and a gas generator connected to a plug. The gas bag has a securing flap that holds the plug affixed to the gas generator.

### FIELD OF THE INVENTION

The present invention relates to a gas bag module.

### BACKGROUND OF THE INVENTION

With some types of gas generators, the electric pulse for activating the igniter is transmitted by a plug that is placed directly onto the protruding connection pins of an igniter arranged inside the gas generator. In such a case, therefore, the plug is in the immediate vicinity of the gas generator. The plug is connected via a cable to a voltage source. If the gas generator is accommodated in a module housing, then the cable extends from the module housing. With such gas bag modules, the plug must remain connected to the gas generator in spite of the impulse generated by the out-flowing hot gases when said gas generator is actuated. Moreover, an optional module housing of the gas bag module has to be sealed in the vicinity of the emerging cable.

### BRIEF SUMMARY OF THE INVENTION

It is an object of the present invention to ensure in a simple manner that the plug cannot detached itself from the gas generator.

This is achieved in a gas bag module comprising a gas bag and a gas generator connected to a plug in that the gas bag has a securing flap that holds the plug affixed to the gas generator. Since the securing flap is part of the gas bag itself, no additional components have to be provided or attached. The securing flap merely has to be arranged in such a suitable manner relative to the plug that the plug cannot detach itself from the igniter pins. The plug protection is not only active during the ignition of the gas generator but it also prevents the plug from being shaken loose by vehicle vibrations. Furthermore, the securing flap can also have a sealing effect, especially if the gas generator is accommodated in a module housing.

Preferably, the securing flap is in direct contact with the plug and encloses it.

The securing flap can be made simply and inexpensively in that it is sewed to the gas bag. It can also be formed by at least one projection of a protection layer arranged on the gas bag. The protection layer is usually formed by an additional piece of fabric, as a rule from gas bag fabric, arranged inside the gas bag. In a simple manner, additional flaps can be provided on the protection layer or layers, optionally integral therewith, said flaps later forming the securing flap.

Preferably, the securing flap is in the form of a strip and projects away from the rest of the gas bag. Thus, it can be wrapped around the plug in such a way as to enclose it and firmly affix it to the gas generator.

A free end of the securing flap is preferably used in order to attach the securing flap to a generator mount.

If the gas bag module has a module housing, the free end of the securing flap is preferably attached to the module housing. Here, e.g., the attachment point of the generator mount suggests itself as a convenient attachment point. In any case, the securing flap is advantageously attached to an element of the gas bag module that is configured so as to be load-bearing, for instance, the generator mount or a section of the module housing that offers an attachment point for the generator mount. Thus, forces acting on the plug, particularly during the actuation of the gas generator, can be absorbed without the free end of the securing flap yielding.

The gas generator can be accommodated, at least for the most part, inside the gas bag.

### BRIEF DESCRIPTION OF THE DRAWINGS

FIG. 1a shows a schematic view of a gas bag module according to the invention before the fixing of the securing flap;

FIG. 2a shows a schematic view of the gas bag module according to FIG. 1, after the fixing of the securing flap;

FIG. 3 shows the gas bag module according to FIG. 2 in a side view;

FIG. 4 shows the gas bag module according to FIGS. 2 and 3, placed inside a module housing;

FIG. 5 shows a flat unfolded gas bag of a gas bag module according to the invention;

FIG. 6 shows a section of a cut-out for a gas bag of a gas bag module according to the invention; and

FIGS. 7a and 7b show protection layers for use in a gas bag of a gas bag module according to the invention.

### DETAILED DESCRIPTION OF A PREFERRED EMBODIMENT

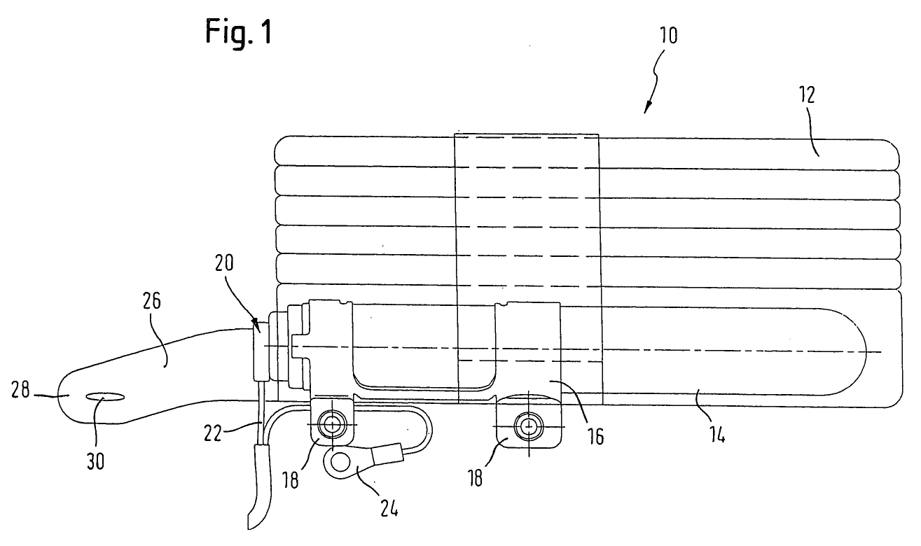

FIG. 1 shows a gas bag module 10 with a folded gas bag 12 and a gas generator 14 in form of an elongated tubular gas generator.

The gas bag module 10 can be used in a vehicle occupant protection system and can, e.g., be mounted in the area of a vehicle seat armrest or a vehicle door.

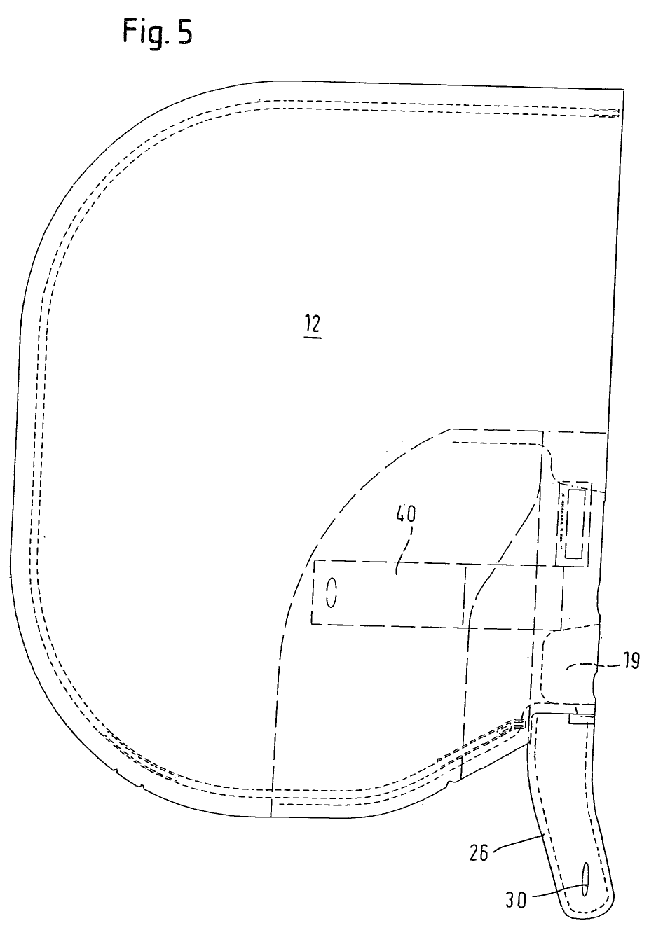

In the gas bag 12 a pocket 19 is formed in which most of the gas generator 14 is accommodated lengthwise (see FIG. 5). At one axial end of the gas generator 14, there is a pyrotechnical igniter (not shown here) onto whose connection pins (not shown) a plug 20 has been placed. The plug 20 is connected to a voltage source (not shown) and, for example, to a control unit (likewise not shown) via a cable 22. Another cable, which ends in a tab 24, serves to ground the gas bag module 10.

The gas generator 14 is enclosed by a clamp-like generator mount 16 that has two attachment tabs 18 facing away from the folded gas bag 12.

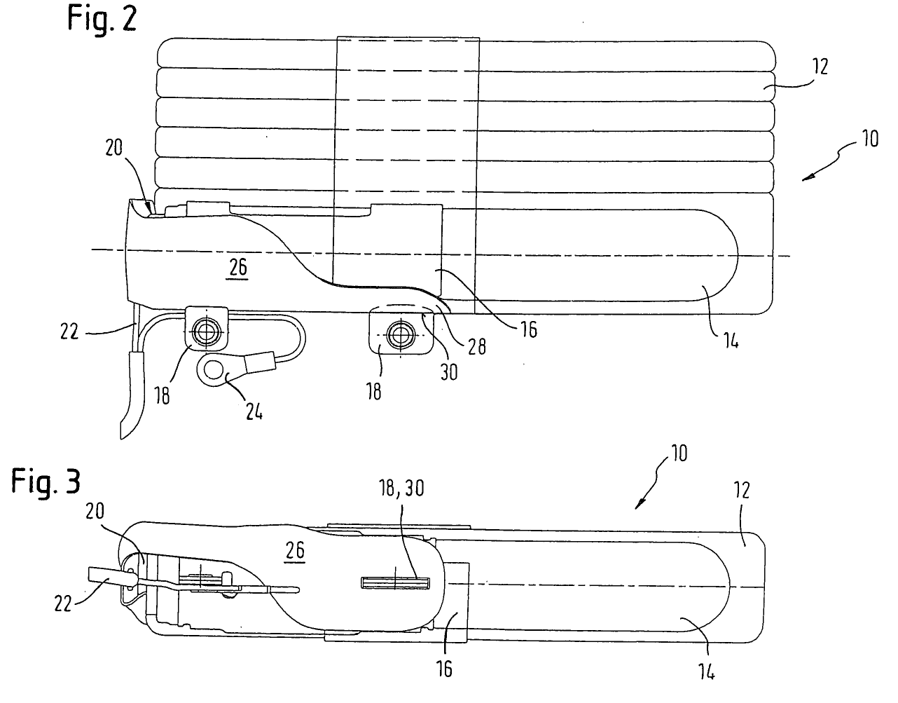

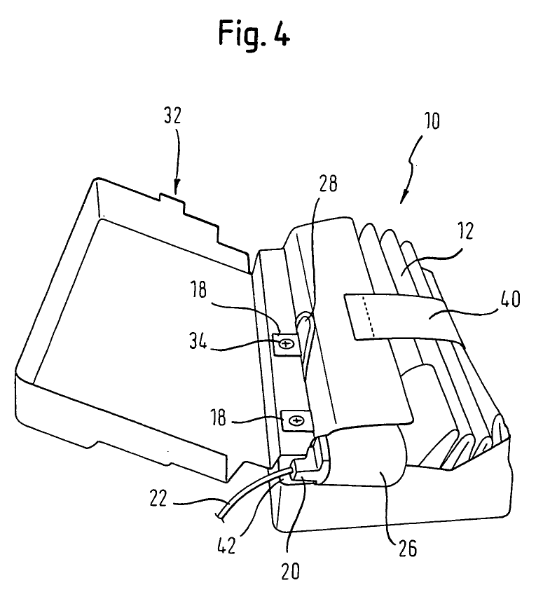

The gas bag 12 has a strip-like securing flap 26 that has an attachment slit 30 in the vicinity of its free end 28. The securing flap 26 serves to affix the plug 20 onto the gas generator 14. This is shown in FIGS. 2 and 3. Here, the securing flap 26 is wrapped around the plug 20 in such a way that it lies tightly against the plug. The attachment slit 30 is pulled over one of the attachment tabs 18 of the generator mount 16, that is to say, the attachment tab 18 protrudes through the attachment slit 30. The securing flap 26 lies tightly and under tension against the plug 20 and the attachment tab 18. As a result, the plug 20 cannot detach itself from the connection pin of the igniter and thus from the gas generator 14. Consequently, the electric connection between the gas generator 14 and the plug 20 is always ensured.

The wrapping of the plug 20 and the further course of the securing flap 26 over the gas bag module 10 is such that the securing flap 26 is not creased but always lies flat against a component.

FIG. 4 shows the gas bag module according to FIGS. 2 and 3 inserted into a module housing 32. The generator mount 16 is firmly connected to the module housing 32 via the attachment tabs 18 by means of screws 34. Through this screwed connection, the free end 28 of the securing flap 26 is connected to the module housing 32.

When the module housing 32 is closed, the attachment points for the attachment tabs 18 of the generator mount 16 lie inside said module housing 32 and are protected by it.

To ground the gas generator 14, the tab 24 is connected to the module attachment point via the attachment tab 18 of the generator mount 16 and from there via one of the screws 34 to an electrically conductive vehicle component.

The securing flap 26 is arranged in the module housing 32 in such a way that it seals the opening in the module housing 32 that is provided for the plug 20 and for the cable 22 during the actuation of the gas generator 14. For this purpose, the width W of the securing flap 26 is selected to have at least the dimension of the passage opening 42.

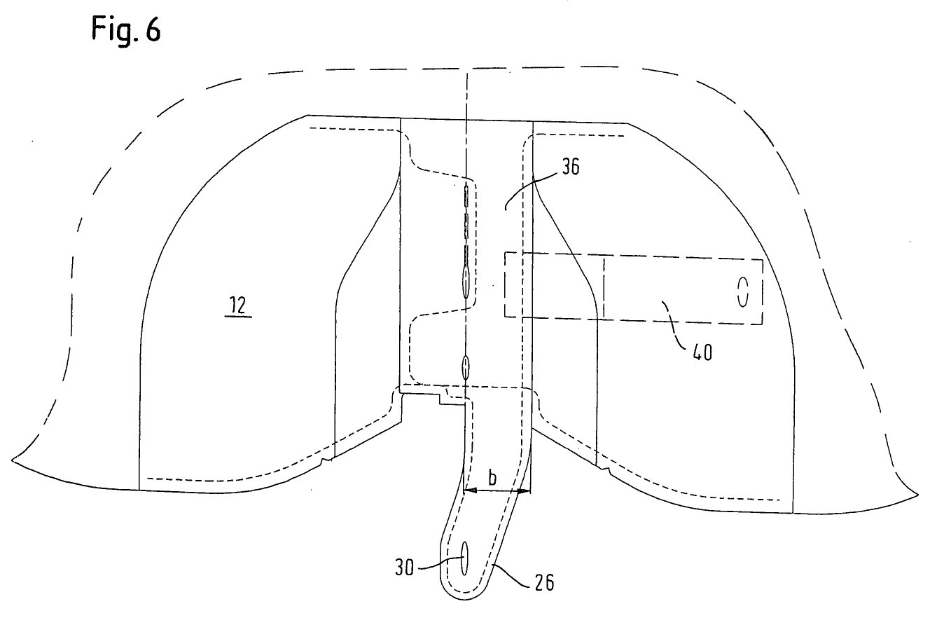

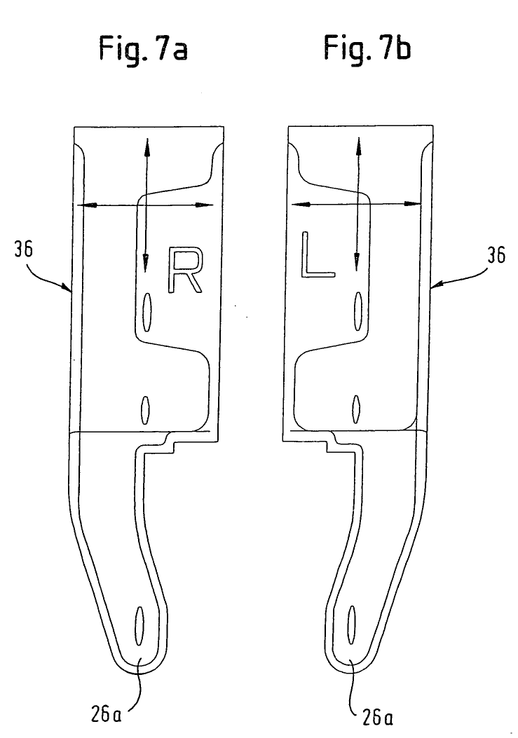

The gas bag 12 consists of a large-surface, single-folded layer of fabric onto which two protection layers 36 made of gas bag fabric are sewed in the vicinity of the gas generator 14 (see FIGS. 7a and 7b). First of all, the protection layers 36 form a pocket 19 for the gas generator. Secondly, each of the protection layers 36 has a strip-like projection 26a that is formed in one piece with the appertaining protection layer 36. When the gas bag 12 is assembled, the projections 26a are sewed together and then form the securing flap 26. FIG. 6 shows the unfolded cut-out of the gas bag 12 in the area of the protection layers 36.

The arrows in FIGS. 7a and 7b indicate the direction of the warp and weft threads in the protection layers 36.

The gas bag 12 has another fabric strip 40 that is used to hold the folded gas bag 12 together before it is expanded. The fabric strip 40 is provided in a known manner with a weakened zone, for example, a tear line, so that it releases the gas bag 12 when the gas generator 14 is ignited.

1. A gas bag module comprising:
a gas bag (12) and
a gas generator (14) connected to a plug (20),
characterized in that the gas bag (12) has a securing flap (26) that holds the plug (20) affixed to the gas generator (14).

2. The gas bag module according to claim 1, wherein the securing flap (26) is sewed to the gas bag (12).

3. The gas bag module according to claim 1, wherein the securing flap (26) is formed by at least one projection of a protection layer (36) arranged in the gas bag (12).

4. The gas bag according to claim 1, wherein the securing flap (26) is in the form of a strip and projects away from the rest of the gas bag (12).

5. The gas bag module according to claim 1, wherein the securing flap (26) encloses the plug (20).

6. The gas bag module according to claim 1, wherein the free end (28) of the securing flap (26) is attached to a generator mount (16).

7. The gas bag module according to claim 1, wherein the gas bag module (10) has a module housing (32) and the securing flap (26) is attached to the module housing (32).

8. The gas bag module according to claim 1, wherein the gas generator (14), at least for the most part, is accommodated inside the gas bag (12).
